(19) United States
(12) Patent Application Publication
(10) Pub. No.: US 2012/0048998 A1
(43) Pub. Date: Mar. 1, 2012

(54) ARRANGEMENT FOR ACCOMMODATING PASSENGERS IN A TRANSPORTATION MEANS

(75) Inventors: Ralf SCHLIWA, Dollern (DE); Maria STRASDAS, Jork (DE); Wolfgang MOELLER, Itzehoe (DE)

(73) Assignee: AIRBUS OPERATIONS GMBH, Hamburg (DE)

(21) Appl. No.: 13/218,247

(22) Filed: Aug. 25, 2011

Related U.S. Application Data
(60) Provisional application No. 61/377,012, filed on Aug. 25, 2010.

(30) Foreign Application Priority Data
Aug. 25, 2010 (DE) 10 2010 035 375.2

(51) Int. Cl. B64D 11/06

(52) U.S. Cl. 244/118.6

(57) ABSTRACT

An arrangement is provided for accommodating passengers in a transportation device that includes, but is not limited to a first positioning space, a second positioning space and a third positioning space that are arranged side by side on a shared positioning area. Two of the positioning spaces comprise an accommodation unit for accommodating a passenger, while one of the positioning spaces is equipped to accommodate a stowage cabinet. The stowage cabinet includes, but is not limited to a first stowage compartment for accommodating a wheelchair which has been folded to its transport position. In this way, persons with restricted mobility can bring along a wheelchair in the transportation means without there being a need to sacrifice additional passenger seat capacity for accommodating a wheelchair brought along in the passenger cabin. Preferably the positioning area is in a region of the passenger cabin close to a door, in which region usually a galley is installed.

### CROSS-REFERENCE TO RELATED APPLICATIONS

This application claims the benefit of the filing date of German Patent Application No. 10 2010 035 375.2 filed Aug. 25, 2010 and of U.S. Provisional Patent Application No. 61/377,012 filed Aug. 25, 2010, the disclosures of which applications are hereby incorporated herein by reference.

### TECHNICAL FIELD

The technical field relates to an arrangement for accommodating passengers in a transportation means, to the use of such an arrangement in an aircraft, and to an aircraft comprising a cabin, and to at least one such arrangement arranged therein.

### BACKGROUND

An important objective when configuring passenger cabins in transportation means often relates to maximization of the available number of passenger seats, which are limited by the prescribed number of seats for crew members, and furthermore by prescribed safety devices, any desired supply devices and lavatories. The ratio of the number of passenger seats to remaining devices in passenger cabins is a factor that helps determine the profitability of an aircraft in regular transport service. Apart from taking into account regulations by authorities, which regulations relate to type approval and operational approval, in the selection of seat sizes, seat pitches, supply devices and lavatories, it is also necessary to take into account customer requirements, for example customer-specific special installations by operators of the transportation means. Depending on the design of monuments in the passenger cabin, and the space these monuments require, intelligent construction and arrangement solutions can optimize the number of passenger seats.

As a result of a general trend to reducing the space used within a passenger cabin for food and drinks carried along, above all in short-haul flights and medium-haul flights, sometimes it is possible to do without galleys, whose positioning areas can then be used for accommodating other objects. Since galleys are frequently arranged in door regions, it may be advisable in these available installation spaces to arrange objects that facilitate the accommodation of persons with restricted mobility. DE 198 27 275 C1 and U.S. Pat. No. 6,273,366 B1 disclose a device for the transport of patients in an aircraft, which device is arranged within the aircraft passenger cabin adjacent to a door region and is designed as a patient transport unit.

It may therefore at least one object to provide an arrangement for accommodating passengers in a means of transport, which arrangement provides as effectively as possible the installation space usually taken up by galleys for accommodating, or for use by, persons, in particular for persons with restricted mobility, persons with an increased requirement for privacy, sick or injured persons and similar, while at the same time as far as possible not limiting the cost effectiveness of the transportation means, but instead additionally improving it. In addition, other objects, desirable features and characteristics will become apparent from the subsequent summary and detailed description, and the appended claims, taken in conjunction with the accompanying drawings and this background.

### SUMMARY

In an embodiment the arrangement for accommodating passengers in a transportation means may comprise a first positioning space, a second positioning space and a third positioning space. The first positioning space, the second positioning space and the third positioning space are arranged side by side on a shared positioning area. In each case two of the positioning spaces comprise a modular accommodation unit for accommodating a passenger, and one of the positioning spaces comprises an accommodation unit for accommodating a stowage cabinet. In this arrangement the positioning area taken up by all three positioning spaces preferably corresponds to the floor space of a galley that is arranged in a non-cylindrical section of a passenger cabin.

Such an arrangement may make it possible to individually configure a region within a passenger cabin of a transportation means, and in particular of an aircraft, which region is normally only used by a galley. In this manner in a separate part of a passenger cabin a facility for accommodating particular passengers can be provided. The modular accommodation units can be implemented by several objects, which relate, in particular, to passenger seats, accommodation units for wheelchairs, or rest platforms. As a result of the suitability of two positioning spaces for accommodation units for passengers it is possible, for example, to accommodate a person with restricted mobility together with an accompanying person. At the same time the transport of an injured or sick person is imaginable, which person is accompanied by an accompanying person, a physician or a caregiver.

If required or if there is a corresponding operative regulation for carrying the wheelchair of a person with restricted mobility along in the passenger cabin during the flight or during the journey, the arrangement may make it possible to accommodate the wheelchair in one of the positioning spaces. The arrangement thus at the same time may make it possible to accommodate a seated passenger and a wheelchair brought along into the passenger cabin so that the transport of a person with restricted mobility in the particular transportation means is significantly facilitated when compared to transportation means from the state of the art. In cabins of commonly used commercial aircraft, presently no self-contained positioning spaces or accommodation units for accommodating wheelchairs that are brought along are provided; instead, frequently for each wheelchair to be brought along in addition several seats within the cabin are sacrificed to make it possible to place folded-up wheelchairs between two seat rows so that, after the aircraft has landed, the wheelchair of a person with restricted mobility is readily available for said wheelchair to be able to easily leave the passenger cabin. However, the provision of a dedicated accommodation unit for a wheelchair beside a normal seat means that if a person with restricted mobility is carried in the transportation means it is not necessary to sacrifice conventional passenger seats, and at the same time bringing along and fastening the wheelchair is significantly facilitated.

The arrangement may thus improve the efficiency of a cabin of the means of transport, which cabin is equipped so as to be adapted to the needs of persons with a disability, while at the same time, depending on the type and design of the accommodation unit for the wheelchair, only very limited additional weight is involved.

The term “positioning space” refers to a location on the floor space of the arrangement according to the invention in which location an item of cabin equipment may be arranged and fastened. A positioning space may, for example, accommodate a passenger seat, a stowage cabinet, part of a rest platform and the like, and may, furthermore, refer to a grid size within the cabin. The term “accommodation unit” is, furthermore, to be understood to the effect that this accommodation unit is used to accommodate something temporarily for the purpose of transport. This may involve passengers, baggage or other items to be carried along, so that an accommodation unit apart from passenger seats may also comprise stowage cabinets, holding devices or locking devices and the like. An accommodation unit for accommodating a wheelchair may be implemented in various ways as shown in the embodiments stated below. The term “wheelchair” has been selected for the sake of simplicity in order to render the description of the invention with greater clarity. It is understood that the arrangement also supports the bringing along of other forms of walking aids or driving aids.

In an improvement of the arrangement, for the purpose of accommodating a stowage cabinet the accommodation unit comprises a stowage cabinet that has a first stowage compartment that is dimensioned for accommodating a wheelchair that has been brought into the cabin, which wheelchair has been folded closed or hinged closed to its transport position. If a person with restricted mobility is wheeled in a wheelchair into the cabin of the corresponding transportation means, the person may be seated or may be laid onto an accommodation unit for a passenger. The corresponding wheelchair that has been brought along may be changed, by means of a locking device, from a functional position to a transport position. The transport position is to allow as compact as possible an accommodation of the particular wheelchair. The stowage cabinet on the corresponding positioning space is then intended to accommodate the folded-up wheelchair. When leaving the cabin, the person concerned may immediately use the wheelchair again.

Likewise, in an embodiment of the arrangement, an accommodation unit for a passenger may also be a locking device for the locked holding of a wheelchair that is in its functional position. In the case of a transportation means that only travels short distances and if the effort of entering and leaving the transportation means is very small, a person with restricted mobility may also be brought into the passenger cabin of the transportation means in a brought-along wheelchair, which in said passenger cabin is docked in a suitable locking device. In this arrangement the locking device is designed to clasp or clamp into position the wheelchair by means of positively and non-positively locking holding devices in such a manner that within the context of the normal design of the transportation means the grip of the locked-down wheelchair corresponds to the grip of normal passenger seats. It must then be ensured that the wheelchair also comprises a belt and buckle device that is at least comparable to the belt and buckle devices of the normal passenger seats.

In an embodiment, on the first and on the third positioning space in each case a passenger seat is arranged, on the second positioning space a stowage cabinet with a first stowage compartment is arranged. The second positioning space is located on a lateral delimitation of the arrangement, while the first positioning space is adjacent to the stowage cabinet. In this arrangement a person with restricted mobility and an accompanying person may be seated side by side on conventional passenger seats while the wheelchair is folded to its transport position and is accommodated in a space-saving manner in a first stowage compartment of the laterally arranged stowage compartment.

In another embodiment, a fourth positioning space exists which is arranged so as to be spaced apart from the first, the second and the third positioning space, and is furthermore designed to accommodate a dividing element. This is used above all to afford privacy to the persons present in the arrangement, for the dividing element may be designed in the form of a spatially firmly positioned dividing wall or in the form of a lamellar variable-length or variable-width variant, so that the view from the other passenger seats to the arrangement and to the passengers located therein is blocked.

In another embodiment the fourth positioning space extends from a position that is spaced apart from the first three positioning spaces to the at least one of the first three positioning spaces and is designed to accommodate a spatial divider. In this manner at least two sides of the arrangement may be enclosed by a divider in order to provide an optimal visual privacy screen.

As a result of the visually separated region, this improvement may also be used for accommodating particularly well-known personalities who insist on maintaining their privacy. Preferably, to this effect, passenger seats present in the arrangement may be arranged so that their seat surfaces face the fourth positioning space, so that the arrangement is visually closed off at least to one or two sides by means of the dividing element, and to another side by means of the backrests of the particular passenger seats.

Such visual closing off is not mandatory, so that in conventional operation of the vehicle a small group of seats may be created which comprises two conventional passenger seats on the second and positioning spaces of the arrangement, as well as a group of passenger seats that faces in the direction of flight, which group is positioned so as to face the arrangement. This is ideal for small groups of travelers or for families.

Likewise, in another embodiment of the arrangement, on at least one positioning space a rest-platform element for reclining transport of a passenger may be arranged, which rest-platform element may extend by folding down, placing on, or the like, to a passenger seat of an adjacent positioning space, or that may be supplemented by a further rest-platform element on an adjacent positioning space. In particular in conjunction with a suitable dividing element in a fourth positioning space, in this manner a mini suite may be implemented, or at least a particularly generous sleeping facility for at least one person, which sleeping facility makes it possible to travel in comfort. The accommodation unit, which is designed to accommodate a stowage cabinet, may in this arrangement remain unoccupied so that adequate space is available on the two remaining positioning spaces. Furthermore, such an arrangement is particularly well suited to patient transport.

In another embodiment, comprising a positioning space with a stowage cabinet with a first stowage compartment for accommodating a wheelchair, a second stowage compartment may be arranged, preferably underneath the first stowage compartment, in order to make it possible to accommodate various objects, for example trolleys. This makes possible particularly effective use of the space in the passenger cabin, in particular if the floor space on which the arrangement is positioned was originally intended for accommodating a galley. As mentioned above, in short-haul flights and medium-haul flights there is a trend to limiting the space used, within a passenger cabin of an aircraft or some other transportation means, for food and drinks carried along, for example by optimizing the packaging of food, by using stowage space outside the cabin, or the like. A galley provided solely for this purpose would be over dimensioned so that, for example, a positioning space for a single trolley or for very few trolleys would be sufficient for transporting the food within the cabin. By arranging an individual second stowage compartment for accommodating a trolley in the region of an entrance door of the particular transportation means, these circumstances may be taken into account.

An aircraft is also provided with a passenger cabin that comprises at least one door for entering or leaving the passenger cabin and that comprises a floor space of the arrangement in a region close to a door, for accommodating an arrangement. Preferably, this floor space of the arrangement is arranged in a front or rear region, when viewed in the direction of flight, of the passenger cabin, in which region the cross section of the passenger cabin tapers off from a purely cylindrical shape towards the front region or towards the aft region. Consequently, the width of this floor space of the arrangement is narrower than the width of a conventional seat row, which is situated in a cylindrical fuselage section of the passenger cabin. As a result of this, the corresponding floor space of the arrangement cannot accommodate the same number of passenger seats that are arranged in a purely cylindrical region of the aircraft fuselage. For this reason in commonly used commercial aircraft this region is preferably taken up by a galley, which based on the explanations set out above can be done without, so that the arrangement may be placed in that space.

Finally, an arrangement is provided in an aircraft.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar objects in the figures have the same reference characters, where:

FIG. 1a and FIG. 1b show a passenger cabin of a short-haul and medium-haul aircraft with a galley (FIG. 1a) arranged in a door region, and an arrangement according to an embodiment of the invention (FIG. 1b) arranged in a door region;

FIG. 2 shows a first exemplary embodiment of the arrangement according to the invention;

FIG. 3 shows a second exemplary embodiment of the arrangement according to the invention;

FIG. 4 shows a third exemplary embodiment of the arrangement according to the invention;

FIG. 5 shows a fourth exemplary embodiment of the arrangement according to the invention;

FIG. 6 shows a fifth exemplary embodiment of the arrangement according to the invention;

FIG. 7 shows a sixth exemplary embodiment of the arrangement according to the invention; and

FIG. 8 shows a three-dimensional view of the first exemplary embodiment.

### DETAILED DESCRIPTION

The following detailed description of the invention is merely exemplary in nature and is not intended to limit application and uses. Furthermore, there is no intention to be bound by any theory presented in the preceding background or summary or the following detailed description.

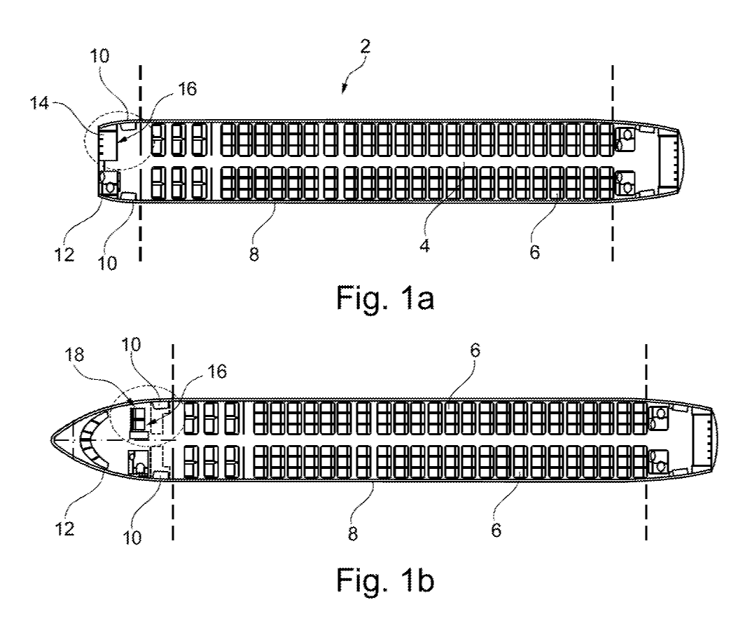

FIG. 1a shows a section of an aircraft 2 with a passenger cabin 4 arranged therein, in which a number of passenger seats 6 are arranged in a two-class distribution arrangement. The passenger seats 6 extend in a region of the passenger cabin 4, which region is delimited by a fuselage section 8 that is of a purely cylindrical shape. In a forward region when viewed in the direction of flight, on both sides of the passenger cabin 4 doors 10 are arranged that are situated in a fuselage section 12 that is not completely cylindrical in shape. In a region close to the door there is usually a galley 14 whose stowage capacity, particularly in the case of short-haul and medium-haul flights, may also be placed in regions of the fuselage that are situated outside the actual passenger cabin, or whose necessary stowage capacity might be able to be done without by reducing package sizes and/or by reducing the quantity of food carried along by means of alternative accommodation options.

A positioning area 16 that is normally taken up by the galley 14 can take up an arrangement 18. As a result of its proximity to a door 10 the arrangement 18 can greatly facilitate boarding for persons with restricted mobility because these persons need not be brought into the actual passenger cabin 4 but instead have a space allocated to them directly beside the door. Furthermore, the distance which sick or injured persons or well-known personalities requiring a high degree of privacy have to cover from an entrance region at the door 10 to a seat or rest platform is very short. The detailed embodiment of the arrangement 18 is explained in more detail with reference to the following figures.

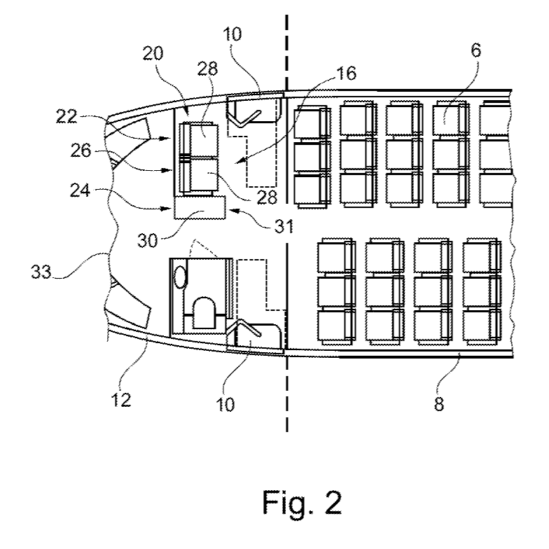

FIG. 2 shows a first exemplary embodiment of an arrangement 20, with a first positioning space 22, a second positioning space 24 and a third positioning space 26 that are arranged adjacent to one another and that share a common positioning area 16. The arrangement 20 is in a region that is positioned in close proximity to an entrance door 10.

The first positioning space 22 comprises a passenger seat 28 that has been rotated so as to face against the direction of flight. Arranged on the second positioning space 24 is a stowage cabinet 30 with a first stowage compartment 31 that is dimensioned for accommodating a wheelchair that can be brought along in the passenger cabin 4 and that has been folded to its transport position. On the third positioning space 26, likewise, a passenger seat 28 is arranged, which is positioned adjacent to the passenger seat 28 of the first positioning space 22. The arrangement 20 is, in particular, suited for accommodating persons with restricted mobility, because the distance from the entrance door 10 to the passenger seat 28 on the first positioning space 22 and on the third positioning space 26 is very short, and the positioning area 16, as a result of the non-cylindrical but tapering-off shape of the aircraft fuselage section 12, would not provide adequate installation space for accommodating three passenger seats 28, which passenger seats 28 can, however, be arranged in a cylindrical fuselage section 8.

The two passenger seats 28 on the first and second positioning spaces 22 and 26 provide adequate space for a person with restricted mobility as well as for an accompanying person who, for example, can assist when the person changes from a wheelchair to a passenger seat 28. Because of the delimitation to a cockpit 33 the passenger seats 28 face against the direction of flight. However, this is useful because in the case of an emergency landing or the like, persons with restricted mobility need not take up an emergency position with the torso bent forward, since as a result of the inertia forces experienced during an emergency landing they are pushed against the backrest so that no great physical exertion is required.

Furthermore, facing against the direction of flight is particularly useful in order to make transposition from a boarding area in front of the entrance door 10 to a passenger seat 28 as easy as possible, because there is no need to wheel a wheelchair around a passenger seat 28 or to walk, but instead a small turn in the region in front of the door 10 is sufficient to get to the passenger seat 28.

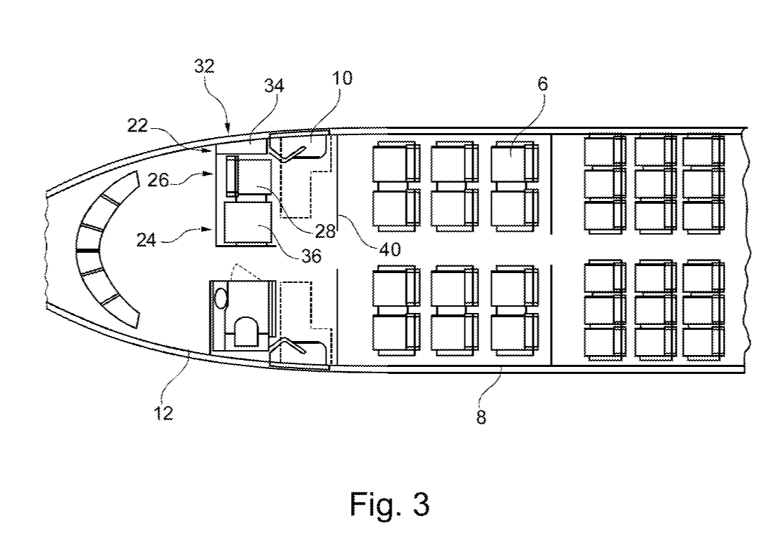

FIG. 3 in a further exemplary embodiment of an arrangement 32 shows a slightly modified variant when compared to that of FIG. 2. On the third positioning space 26 a passenger seat 28 is arranged, on the first positioning space 22, which faces the wall of the aircraft fuselage section 12, a stowage cabinet 34 is arranged, while on the second positioning space 24, which faces an aisle, a locking device 36 for a wheelchair is arranged. The locking device 36 makes it possible to fully accommodate a wheelchair in its functional position and to lock it, which appears sensible in particular in the case of short-haul flights when the effort of changing places, folding the wheelchair and stowing it in a baggage compartment or a cargo space does not appear necessary. This may, in particular, also make sense in other means of local transport, for example in buses or trains. For this reason the stowage cabinet 34 arranged on the first positioning space 22 need not be equipped for accommodating a folded-up wheelchair because the wheelchair is positioned in the locking device 36 and in this position it is possible for a person to be seated in it.

Furthermore, in the region of the entrance door 10 there is a fourth positioning space 38, in which a dividing element 40 may be arranged to ensure a visual privacy screen. The passengers on the second and third positioning space 24 or 26 are thus afforded privacy, which makes sense in particular as a result of the position of the passenger seat 28 and the locking device 36 optionally facing against the direction of flight.

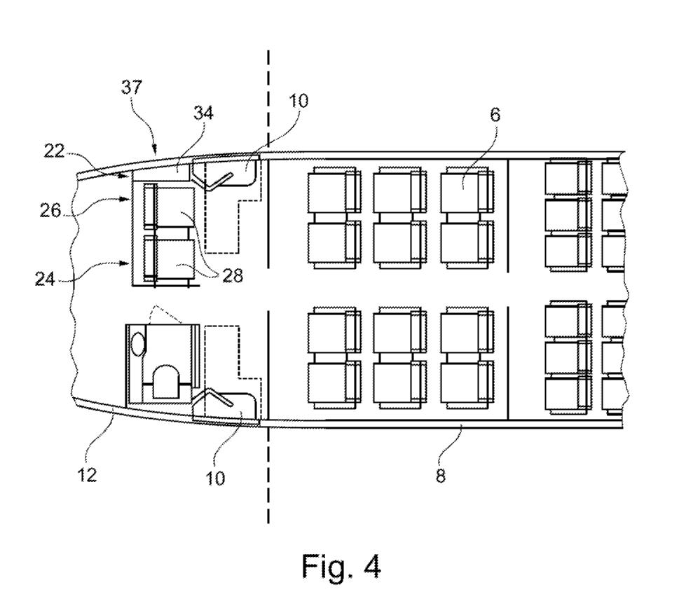

FIG. 4 shows a third exemplary embodiment of an arrangement 37, in which on the second and third positioning space 24 and 26 in each case a passenger seat 28 is arranged, which as is the case in FIG. 2 are intended for accommodating passengers, in other words a passenger with restricted mobility and an accompanying person, wherein a stowage cabinet 34 arranged on the second positioning space 24 is designed for the storage of passengers' personal belongings on the second positioning space 24 and on the third positioning space 26.

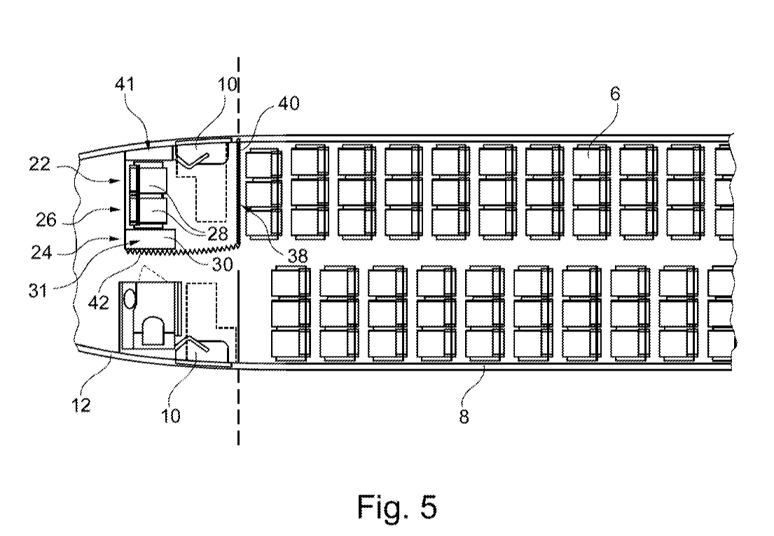

FIG. 5 shows a further exemplary embodiment of an arrangement 41, which exemplary embodiment essentially corresponds to the exemplary embodiment of FIG. 2. In addition to this in the third positioning space 38 a dividing element 40 is arranged that comprises an extendable curtain 42 that can be pulled along a longitudinal side of the arrangement 41, thus extending into the second positioning space 24. As a result of the combination comprising the curtain 42 and the dividing element 40 a closed space with a high degree of privacy can be provided that extends into a boarding area which is otherwise not usually used during the flight. Furthermore, this makes it possible for the entire passenger cabin 4 to be occupied by passengers, and subsequently to close the curtain 42 to make it possible, for example, for a well-known personality to enter without being noticed, which allows a significant improvement in privacy when compared to the arrangements in all known passenger aircraft.

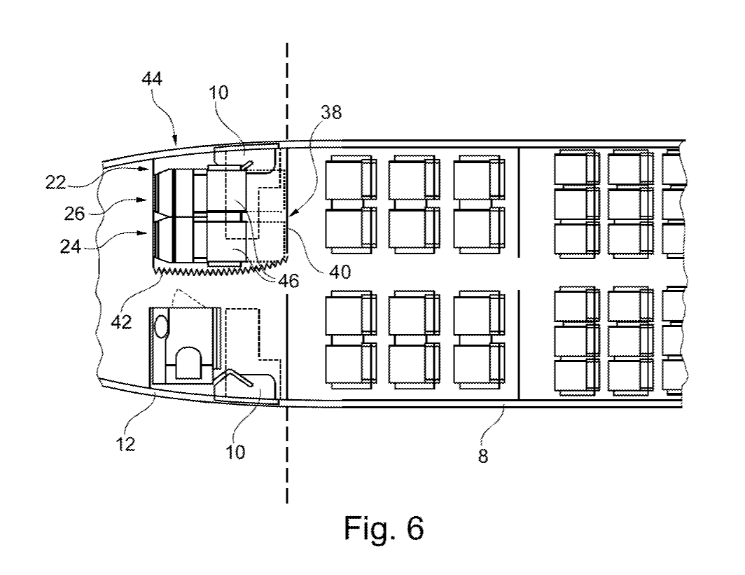

FIG. 6 shows a slight modification of the exemplary embodiment shown in FIG. 5 in an arrangement 44, which is, in particular, intended to ensure privacy while providing more generous seating with passenger seats 46. Because of the modular concept the first positioning space can remain unoccupied so that the second positioning space 24 and the third positioning space 26 can be equipped with larger passenger seats 46.

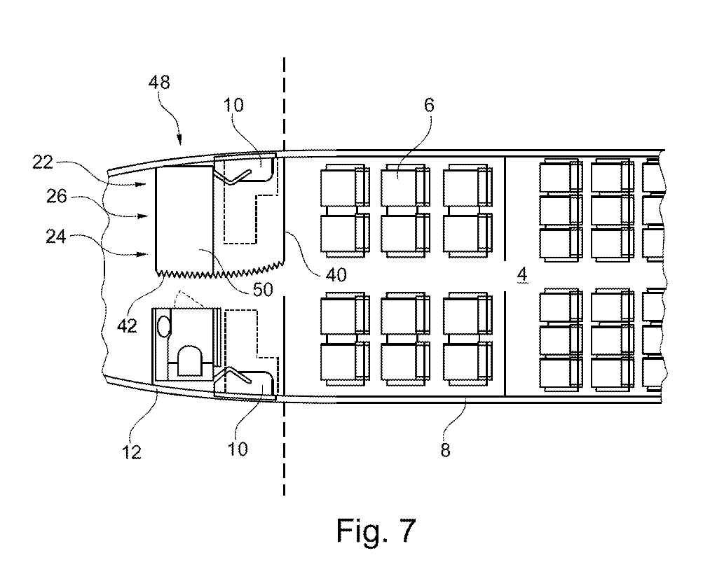

FIG. 7 shows a further exemplary embodiment of an arrangement 48, in which all the positioning spaces 22, 24 and 26 are taken up by a rest platform 50 that is visually shielded from the outside by means of a dividing element 40 and a curtain 42. This makes undisturbed patient transport possible within a conventional passenger cabin equipped with an arrangement 48 without a significantly more expensive transportation means having to be used for patient transport.

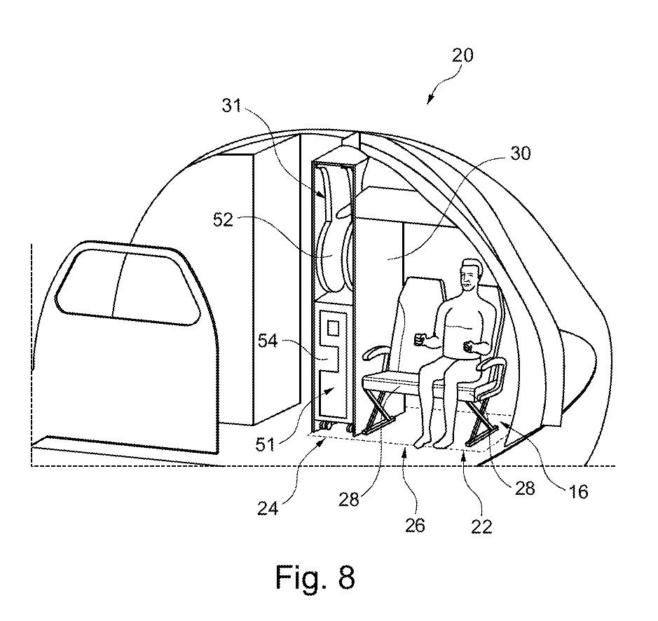

Finally, FIG. 8 shows a three-dimensional view of the first exemplary embodiment of an arrangement 20 according to FIG. 2, in which there are two passenger seats 28 which on a side facing the aisle of the passenger cabin are delimited by a stowage cabinet 30 comprising a first stowage compartment 31 and a second stowage compartment 51, wherein the first stowage compartment is dimensioned in such a manner that a wheelchair 52 in its transport position can be entirely accommodated. According to this exemplary embodiment, the second stowage compartment 51 may be designed to accommodate a trolley 54 by means of which food and drinks can be served in the passenger cabin. In order to be able to accommodate commonly-used wheelchairs, the dimensions of the first stowage compartment 31 should be approximately 13×36×42 inches.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A modular arrangement for accommodating passengers in a cabin of a transportation apparatus, comprising:
a shared positioning area;
a first positioning space;
a second positioning space; and
a third positioning space,
wherein the first positioning space, the second positioning space and the third positioning space are arranged side by side on the shared positioning area, in each case two of the first positioning space, the second positioning space, or the third positioning space comprise an accommodation unit for accommodating a passenger, and one of the first positioning space, the second positioning space, or the third positioning space is designed for accommodating a stowage cabinet.

2. The modular arrangement of claim 1, wherein the stowage cabinet has a first stowage compartment that is dimensioned for accommodating a wheelchair that has been folded to a transport position.

3. The modular arrangement of claim 1, wherein the accommodation unit for accommodating the passenger is a locking device for the locked holding of a wheelchair that is in a functional position.

4. The modular arrangement of claim 1, wherein in the first positioning space and the third positioning space a passenger seat is arranged, and in the second positioning space, the stowage cabinet is arranged.

5. The modular arrangement of claim 1, further comprising a fourth positioning space which is arranged so as to be spaced apart from the first positioning space, the second positioning space and the third positioning space and comprises a dividing element.

6. The modular arrangement of claim 5, further comprising a curtain that extends from the dividing element to one of the first positioning space, the second positioning space, and the third positioning space.

7. The modular arrangement of claim 1, comprising a rest platform on at least one positioning space, the rest platform extends to at least one adjacent positioning space.

8. The modular arrangement of claim 2, wherein the stowage cabinet comprises a second stowage compartment that is designed for accommodating a trolley.

9. An aircraft, comprising:
a passenger cabin; and
a modular arrangement for accommodating passengers in the passenger cabin, comprising:
a shared positioning area;
a first positioning space;
a second positioning space; and
a third positioning space,
wherein the first positioning space, the second positioning space and the third positioning space are arranged side by side on the shared positioning area, in each case two of the first positioning space, the second positioning space, or the third positioning space comprise an accommodation unit for accommodating a passenger, and one of the first positioning space, the second positioning space, or the third positioning space is designed for accommodating a stowage cabinet.

10. The aircraft of claim 9, wherein the stowage cabinet has a first stowage compartment that is dimensioned for accommodating a wheelchair that has been folded to a transport position.

11. The aircraft of claim 9, wherein the accommodation unit for accommodating the passenger is a locking device for the locked holding of a wheelchair that is in a functional position.

12. The aircraft of claim 9, wherein in the first positioning space and the third positioning space a passenger seat is arranged, and in the second positioning space, the stowage cabinet is arranged.

13. The aircraft of claim 9, further comprising a fourth positioning space which is arranged so as to be spaced apart from the first positioning space, the second positioning space and the third positioning space and comprises a dividing element.

14. The aircraft of claim 13, further comprising a curtain that extends from the dividing element to one of the first positioning space, the second positioning space, and the third positioning space.

15. The aircraft of claim 9, comprising a rest platform on at least one positioning space, the rest platform extends to at least one adjacent positioning space.

16. The aircraft of claim 9, wherein the stowage cabinet comprises a second stowage compartment that is designed for accommodating a trolley.

17. The aircraft of claim 9, wherein the modular arrangement is positioned in an entrance region at a door.
